(19) United States
(12) Patent Application Publication
(10) Pub. No.: US 2014/0370953 A1
(43) Pub. Date: Dec. 18, 2014

(54) METHOD AND APPARATUS FOR A POKER GAME

(71) Applicants: Ashok K. Singh, Henderson, NV (US); Rohan J. Dalpatadu, Las Vegas, NV (US); Arjun K. Singh, Henderson, NV (US); Anthony F. Lucas, Henderson, NV (US)

(72) Inventors: Ashok K. Singh, Henderson, NV (US); Rohan J. Dalpatadu, Las Vegas, NV (US); Arjun K. Singh, Henderson, NV (US); Anthony F. Lucas, Henderson, NV (US)

(21) Appl. No.: 13/915,866

(22) Filed: Jun. 12, 2013

(51) Int. Cl. G07F 17/32

(52) U.S. Cl. CPC G07F 17/3293
USPC 463/13

(57) ABSTRACT

A game is illustrated and described having a number of rows R and a number of columns C arranged in an R×C matrix, where R defines the number of rows displayed to a player and where C defines the number of columns displayed to the player. In one embodiment, a separate virtual reel is provided for each column and a separate set of symbols is associated with each virtual reel. A symbol is then randomly selected for each position in the R×C matrix from the set of symbols associated with the virtual reel provided for the column. In another embodiment, a method of stud or draw poker is disclosed, in which cards are dealt in a pattern, and the player is allowed to move the cards within the pattern, i.e., rearrange the pattern so as to increase the payout or value of the hand. The payout of the hand is determined by the total value of poker hands on designated pay lines in a pattern.

### FIELD

The present invention relates generally to gaming systems, and methods for playing wagering games, and more particularly, to the field of skill-based poker games that involve dealing multiple poker hands to a player.

### BACKGROUND

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. The introduction of social media has expanded the reach and play of the games associated with gaming terminals to a much broader market. Many games that were typically only available for play at a physical casino are now available for “free” play online.

### BRIEF DESCRIPTION OF THE FIGURES

FIG. 1 illustrates on embodiment of a gaming device for implementing aspects of game play;

FIG. 2 illustrates a schematic view of one embodiment of the components associated with the gaming device of FIG. 1;

FIG. 3 illustrates one embodiment of the environment for implementing the social gaming aspect of the game play;

FIG. 4 illustrates one embodiment of a plurality of virtual or physical playing cards arranged in a 3×3 matrix;

FIG. 5 illustrates one embodiment of a plurality of pay lines associated with a 3×3 matrix;

FIGS. 6 and 7 illustrates one embodiment of a plurality of virtual or physical playing cards arranged in a 3×5 matrix;

FIG. 8 illustrates one embodiment of a plurality of pay lines associated with a 3×5 matrix;

FIGS. 9 and 10 illustrate embodiments of flow charts of game play;

FIG. 11 illustrates one embodiment of the multi-deck poker matrix game;

FIG. 12 illustrates one example of a pay table associated with a multi-deck poker matrix game;

FIG. 13 shows a display of a Free Spin Screen; and

FIG. 14 illustrates one embodiments of a flow charts of game play for a multi-deck poker matrix game.

### BRIEF SUMMARY

In one embodiment, a computerized method for playing an game having a number of rows R and a number of columns C arranged in an R×C matrix is provided. In the illustrated embodiment, R defines the number of rows displayed to a player and where C defines the number of columns displayed to the player. A display configured for displaying a plurality of symbol positions within the rows and columns of the R×C matrix is provided, where each symbol position is defined by the intersection of a row and a column, and further where the number of symbol positions in each column are defined by the number of rows in the R×C matrix. A separate virtual reel is provided for each column. A set of symbols is associated with each virtual reel, where each set of symbols for each virtual reel are equal in number and identity. A plurality of pay lines is provided, each pay line associated with a preselected number of positions from the plurality of symbol positions.

An indication of a wager associated with one or more of the pay lines is received from the player. For each position in a column, a symbol is randomly selected from the set of symbols associated with the virtual reel provided for the column. The plurality of symbol positions associated with each column are then populated with the randomly generated symbols from the virtual reel provided for the column. The selected pay lines and the randomly generated symbols are displayed. The pay lines having a wager associated therewith are evaluated for winning combinations of symbols, where the winning combinations identify a plurality of symbols that make up a predetermined combination of symbols in a pay table. A player is paid a winning wager associated with a pay line having a winning combination of symbols, said winning wager being determined based upon a multiple of the wager associated with the winning combination of symbols.

In another embodiment, the symbols are virtual playing cards, and the set of symbols is a virtual deck of 52 virtual playing cards.

In yet another embodiment, a computerized method for playing a poker game is provided. Typically, a matrix is provided having a plurality of positions arranged in rows and columns for receiving a plurality of virtual playing cards. A plurality of pay lines is also provided where each pay line is associated with a row, column or diagonal of positions in the matrix. An indication of a wager associated with one or more of the pay lines is received. In response, a virtual playing card is generated in each of the plurality of positions in the matrix. The matrix and the virtual playing cards in each position are displayed. An option is provided to the player for rearranging one or more of the virtual playing cards in the matrix. The system evaluates the matrix for winning poker combinations of virtual playing cards on the pay lines where the player placed a wager. The pay line identifies a plurality of virtual playing cards that make up a poker hand. The player is paid a winning wager associated with a pay line having a winning poker combination where the winning wager is determined based upon a multiple of the wager associated with a poker hand value.

In another embodiment, a method for playing a card game at a gaming table is provided. The gaming table and a single deck of playing cards are provided, typically in casino environment. A matrix is provided on the gaming table having a plurality of positions arranged in rows and columns for receiving a plurality of the playing cards. A plurality of pay lines is also provided on the gaming table where each pay line associated with a row, column or diagonal of positions in the matrix. A player places a wager with one or more of the pay lines. The playing cards are dealt from a deck of playing cards to the plurality of positions in the matrix. The player is given an option to rearrange one or more of the playing cards in the matrix. The matrix is evaluated for winning poker combinations of playing cards on the pay lines having a wager associated therewith, where each pay line identifies a plurality of playing cards that make up a poker hand. The player is paid a winning wager associated with a pay line having a winning poker combination based upon a multiple associated with a poker hand value.

In another embodiment, the wager multiple is determined by a pay table, where the structure of the pay table is arranged to show a multiple associated with a winning poker hand value.

In another embodiment, the matrix is a 3×3 matrix having three rows and three columns.

In yet another embodiment, the matrix is a 3×5 matrix having three rows and five columns.

### BRIEF DESCRIPTION

Reference to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others. In general terms, an algorithm is conceived to be a self-consistent sequence of steps leading to a desired result. The steps of an algorithm require physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. It is further contemplated within the scope of this invention that calculations can also be done mentally, manually or using processes other than electronic.

The present invention also relates to one or more apparatus for performing the operations herein. This apparatus may be specially constructed for the required purposes, or it may comprise a general-purpose computer selectively activated or reconfigured by a computer program stored within the computer. Such a computer program may be stored in a machine readable storage medium, such as, for example, any type of disk including floppy disks, optical disks, CD-ROMs, magnetic-optical disks, read-only memories (ROMs), random access memories (RAMs), EPROMs, EEPROMs, magnetic or optical card, or any type of media suitable for storing electronic instructions and coupled to a computer system bus.

The algorithms and displays presented and described herein are not inherently related to any particular computer or other apparatus or apparatuses. Various general-purpose systems may be used with programs in accordance with the teachings, or it may prove convenient to construct more specialized apparatus to perform the required method steps. The required structure for a variety of these systems will become readily apparent from the description alone. In addition, the present invention is not described with reference to any particular programming language, and accordingly, a variety of programming languages may be used to implement the teachings of the illustrated invention.

The present disclosure may be implemented in various configurations for gaming machines, gaming devices, or gaming systems, including but not limited to: (1) a dedicated gaming machine, gaming device, or gaming systems wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment.

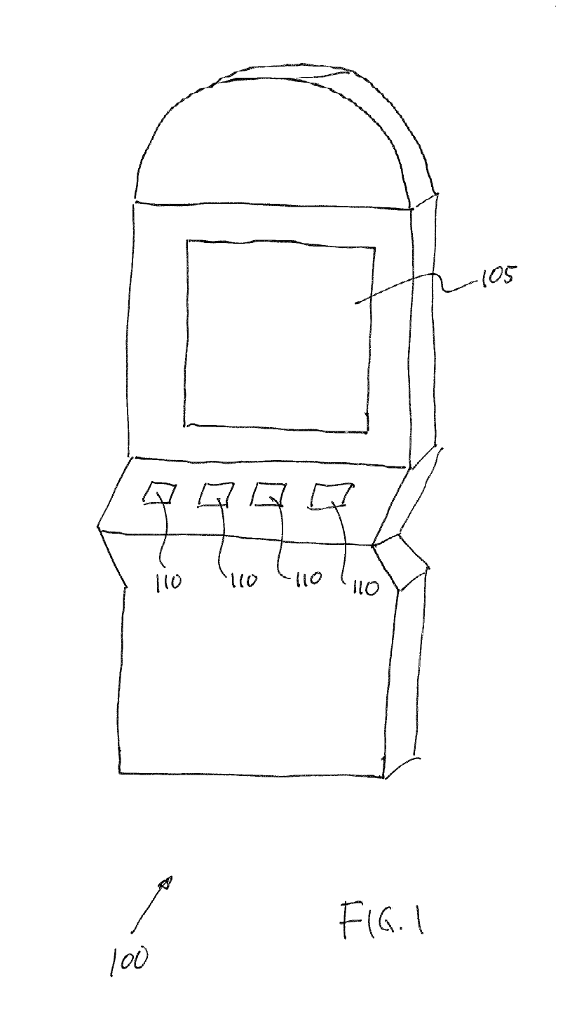

In the embodiments illustrated in FIG. 1, gaming device 100 has a support structure, housing, or cabinet which provides support for a display 105, inputs 110, controls, and other features of a conventional gaming machine. It is configured so that a player can operate it while standing or sitting. The gaming device can be positioned on a base or stand or can be configured as a pub-style table-top game (not shown) which a player can operate preferably while sitting. As illustrated by the different configurations shown in FIG. 1, the gaming device may have varying cabinet and display configurations.

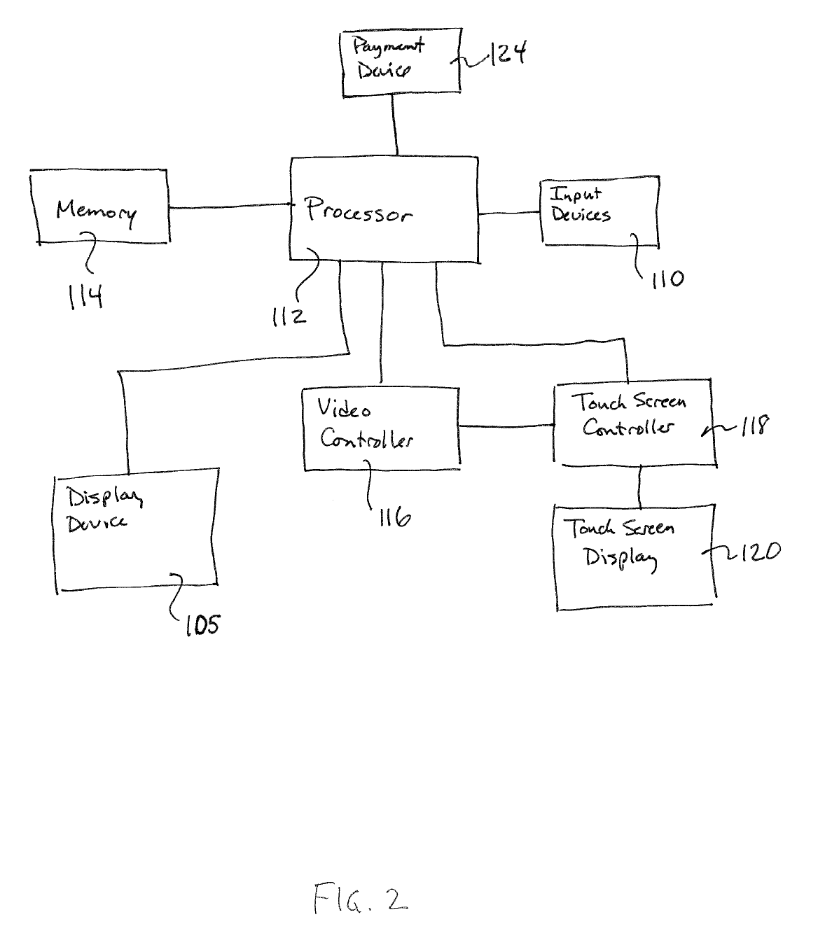

In one embodiment, as illustrated in FIG. 2, the gaming device preferably includes at least one processor 112, such as a microprocessor, a microcontroller-based platform, a suitable integrated circuit or one or more application-specific integrated circuits (ASIC's). The processor is in communication with or operable to access or to exchange signals with at least one data storage or memory device 114. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information, and applicable game rules that relate to the play of the gaming device. In one embodiment, the memory device includes random access memory (RAM), which can include non-volatile RAM (NVRAM), magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

In one embodiment, the gaming device randomly generates awards and/or other game outcomes based on a probability table. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In one embodiment, as illustrated in FIG. 2, the gaming device includes one or more display devices controlled by the processor. The display devices are preferably connected to or mounted on the cabinet of the gaming device. The embodiment shown in FIG. 1 includes a central display device 105 which displays a game. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In one embodiment, as described in more detail below, the display device includes a touch-screen with an associated touch-screen controller. The display devices may be of any suitable size and configuration, such as a square, a rectangle or an elongated rectangle.

The display devices of the gaming device are configured to display at least one and preferably a plurality of game or other suitable images, symbols and indicia such as any visual representation or exhibition of the movement of objects such as mechanical, or video reels and wheels, dynamic lighting, video images, images of people, characters, places, things, faces of cards, and the like.

As illustrated in FIG. 2, in one embodiment, the gaming device includes at least one payment device 124 in communication with the processor. As seen in FIG. 1, a payment device such as a payment acceptor includes a note, ticket or bill acceptor wherein the player inserts paper money, a ticket, or voucher and a coin slot where the player inserts money, coins, or tokens. In other embodiments, payment devices such as readers or validators for credit cards, debit cards or credit slips may accept payment. In one embodiment, a player may insert an identification card into a card reader of the gaming device.

As seen in FIGS. 1 and 2, in one embodiment the gaming device includes at least one and preferably a plurality of input devices 110 in communication with the processor. The input devices can include any suitable device which enables the player to produce an input signal which is received by the processor.

In one embodiment, as mentioned above and as seen in FIG. 2, one input device is a touch-screen display 120 coupled with a touch-screen controller 118 or some other touch-sensitive display overlay to allow for player interaction with the images on the display. The touch-screen and the touch-screen controller are connected to a video controller 116. A player can make decisions and input signals into the gaming device by touching the touch-screen at the appropriate locations. One such input device is a conventional touch-screen button panel.

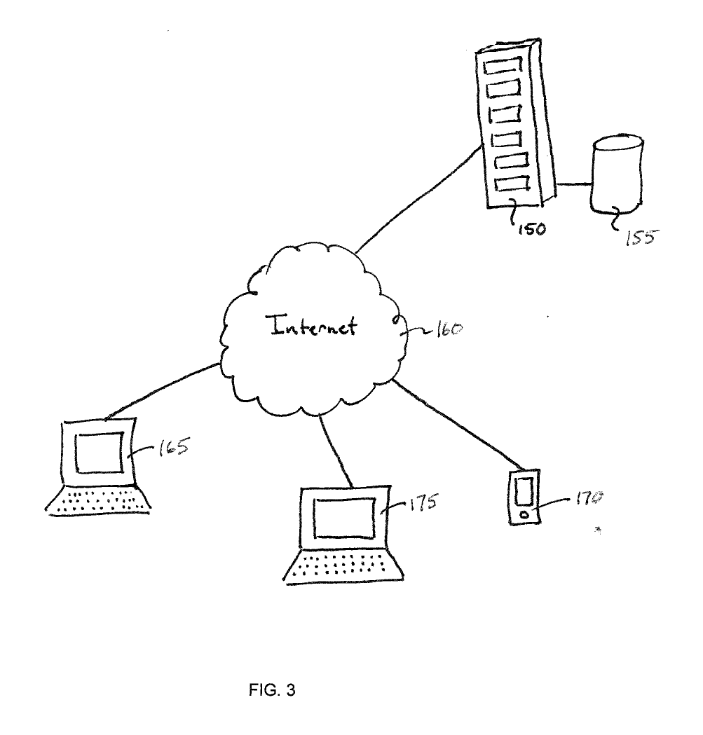

The present disclosure may also be implemented in various configurations for online social media play, such as the platforms for Facebook, Google and Yahoo! games. In one embodiment, FIG. 3 illustrates a schematic view of a typical hosting/access environment for implementing the present invention. In one embodiment, aspects of the present invention may be hosted on a server 150 coupled to a storage device 155. Typically, storage device 155 is a database configured to store multiple records of users of the website described herein. In one embodiment, the database is a secure database capable of storing information in accordance with privacy laws of the United States and countries that allow access to the web site of the present invention.

In most cases, server 150 is coupled to Internet 160 so as to provide access to users of the site of the present invention. Users may access the website of the present invention in several different ways. In one embodiment, a user may use his or her personal computer or desktop computer 165 to access the information located on server 150. In another embodiment, a user may choose to use his or her PDA device or cell phone 170 to access the information on server 150. In any event, any suitable device may be used to access server 150, including a direct connection not connected to Internet 160, so long as the connection is secure and able to receive information from the hosted website. In addition to a user of the website described herein, a site administrator may access the server 150 through a remote access over the Internet 160 using a personal computer 175 or other secure device to remotely update game content or game play.

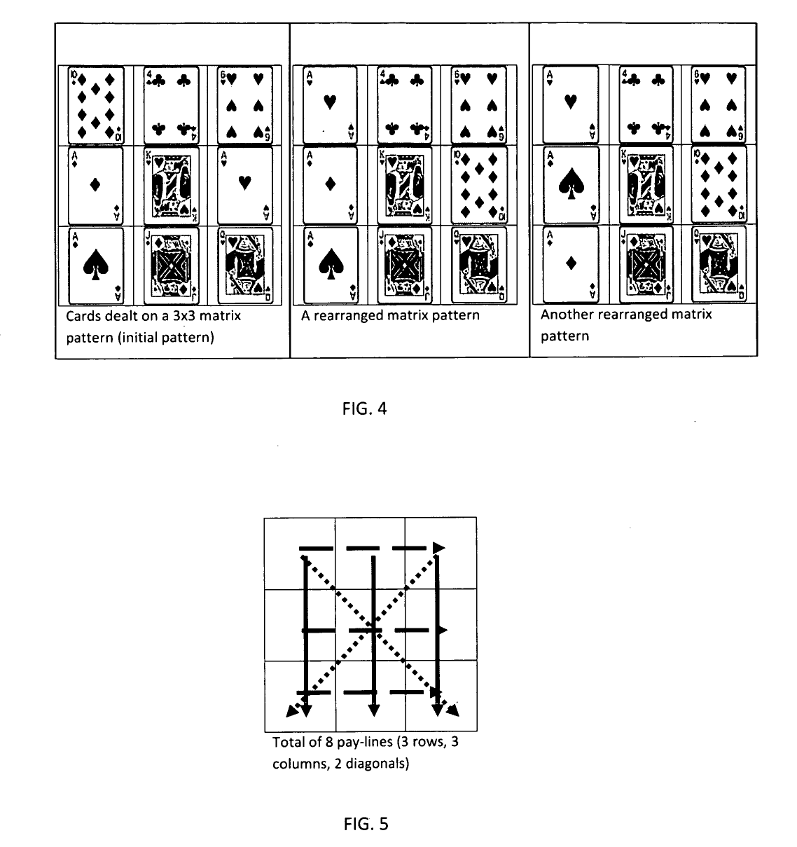

FIGS. 4 through 8 illustrate exemplary game play pages that may be provided or “served” by server 15 to one or more computers 165, 175 or PDA devices 170 to facilitate the environment of the present invention. It should be understood that many other appropriate game play pages may be provided in addition to or instead of the illustrated game play pages, which are provided only as examples. Appropriate modifications may be made to the content of the game play pages for transactions involving items other than the content illustrated and described with respect to FIGS. 4 through 8

In the following description, numerous specific details are set forth, such as examples of specific shapes, components etc., in order to provide a thorough understanding of the present invention. It will be apparent, however, to one skilled in the art that the present invention may be practiced without these specific details. In other instances, well known components or methods have not been described in detail but rather in general terms in order to avoid unnecessarily obscuring the present invention. Thus, the specific details set forth are merely exemplary. The specific details may be varied from and still be contemplated to be within the spirit and scope of the present invention.

Matrix Poker with Optional Rearrange Feature

As illustrated in FIGS. 4-8, one embodiment illustrates a single or multiple deck poker game that is played on a matrix (e.g., a 3×3 matrix, or a 3×5 matrix). As shown in FIG. 4, if the game is offered on a 3×3 matrix, then the player plays a total of eight 3-card poker hands (along 3 columns, 3 rows, and 2 diagonals). After a player is dealt nine cards on a 3×3 matrix, the player has the option of rearranging cards within the 3×3 matrix so as to maximize the total value of all eight 3-card poker hands. In another embodiment, the game may be offered in such a way that the player rearranges the 9 cards within a pre-specified amount of time.

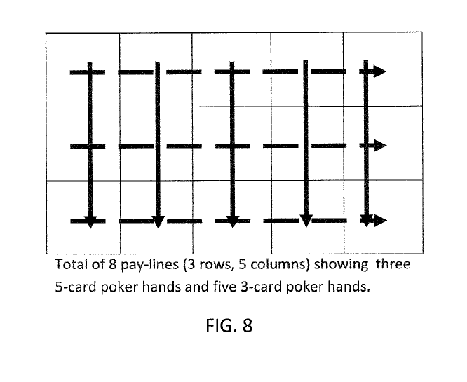

As shown in FIG. 6, if the game is offered on a 3×5 matrix, the player plays a total of five 3-card poker hands (along five columns), and three 5-card poker hands (along three rows). In the illustrated embodiment, after a player is dealt fifteen cards on a 3×5 matrix, the player has the option of rearranging cards within the 3×5 matrix so as to maximize the total value of all 8 poker hands. In another embodiment, the game may be offered in such a way that the player must rearrange the 15 cards within a pre-specified amount of time. Either of the two games can be offered as a single player game, a player vs. dealer game, or a multi-player game. Either of the two games can be offered as a table game or an electronic slot game.

One example of payback amounts for a single credit wager on any one line of the 3×3 matrix poker (i.e., the value of a 3-card poker hand) is shown in Table 1.

TABLE 1
The payback amounts
or value of a 3-card poker hand
for a single credit wager on any
one line of the 3 × 3 matrix poker

| Hand | Payback |
|---|---|
| Royal Flush | 200 |
| Straight Flush | 50 |
| Three of a kind | 50 |
| Straight | 4 |
| Flush | 3 |
| Pair | 2 |
| Nothing | 0 |

One example of payback amounts for a single credit wager on any one horizontal line of the 3×5 matrix poker (i.e., the value of a 5-card poker hand) is shown in Table 2.

TABLE 2
The payback amounts or
value of a 5-card poker hand for a
single credit wager on any one
horizontal line of the 3 × 5 matrix poker

| Hand | Payback |
|---|---|
| Royal flush | 800 |
| Straight flush | 50 |
| 4 of a kind | 80 |
| Full house | 8 |
| Flush | 5 |
| Straight | 4 |
| 3 of a kind | 4 |
| Two pair | 1 |
| Jacks or better | 1 |
| Nothing | 0 |

One of ordinary skill in the art will appreciate that Table 1 may be used for the value of a 3-card poker hand for the 3×5 matrix poker game. It should be noted that these values are for example only, and would need to be optimized for these games to be offered as casino games.

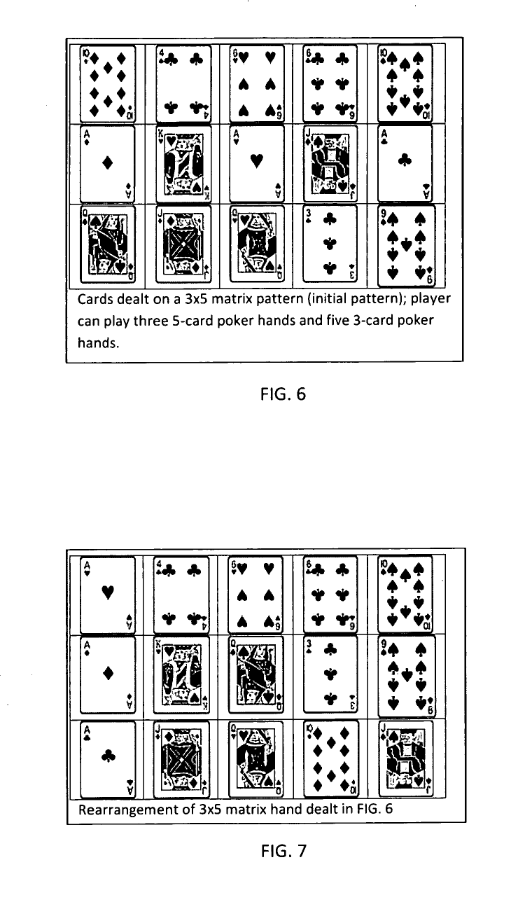

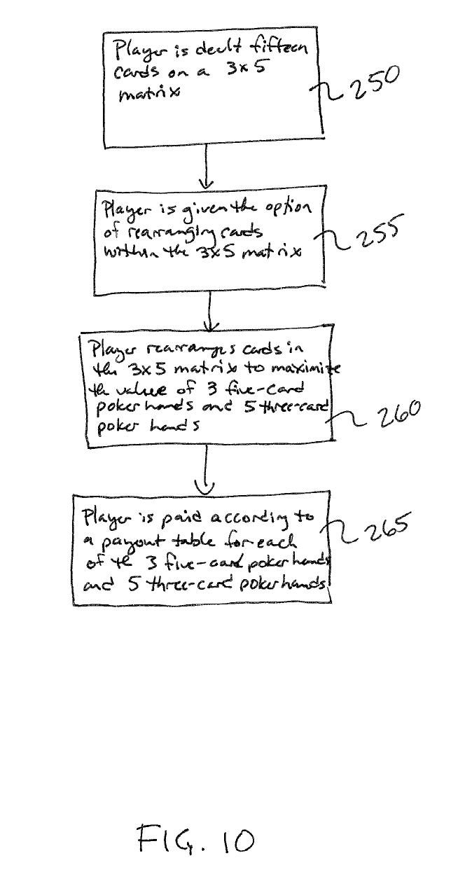

FIG. 9 illustrates a flowchart of the game play associated with one example of the 3×3 matrix poker game. In step 200, the player is dealt nine cards on a 3×3 matrix. Continuing in step 205, the player is given the option of rearranging cards in the 3×3 matrix. So, the player may move no cards or the player may rearrange all of the cards. As shown in step 210, the player rearranges the cards to maximize the value of 8 three-card poker hands. As shown in FIG. 5, the eight hands are formed on three horizontal pay-lines, three vertical pay-lines and two diagonal pay-lines. In step 215, the player is paid according to the value of each three-card poker hand.

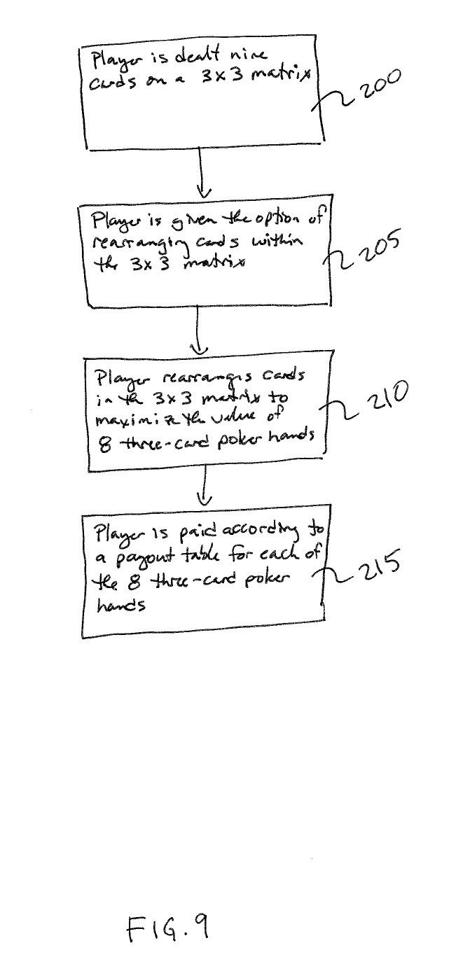

FIG. 10 illustrates a flowchart of the game play associated with one example of the 3×5 matrix poker game. In step 250, the player is dealt fifteen cards on a 3×5 matrix. Continuing in step 255, the player is given the option of rearranging cards in the 3×5 matrix. So, similar to play in the 3×3 matrix, the player may rearrange no cards or the player may rearrange all of the cards. As shown in step 260, the player rearranges the cards to maximize the value of 5 three-card poker hands and 3 five-card poker hands. As shown in FIG. 8, the eight hands are formed on three horizontal pay-lines and five vertical pay-lines. In step 265, the player is paid according to the value of each of the 5 three-card poker hands and 3 five-card poker hands.

In another embodiment, the computerized method associated with play of the 3×3 and 3×5 matrix poker game provides a matrix having a plurality of positions arranged in rows and columns for receiving a plurality of virtual playing cards. For example, the virtual playing cards may be presented to the player as symbols representing each card in a fifty two card deck, or the symbols may be unique symbols for playing a slot-type game. One of ordinary skill in the art will appreciate that any type of symbol may be used without departing from the scope and spirit of the present invention. In addition to the matrix, the game provides the player with a plurality of pay lines, each pay line associated with a row, column or diagonal of positions in the matrix. Prior to the game “dealing” the virtual playing cards and filling the plurality of positions within the matrix, the player makes a wager on one or more of the pay lines and the game receives an indication of a wager associated with one or more of the pay lines. In response, the game play generates virtual playing cards in the plurality of positions in the matrix and displays the matrix and the virtual playing cards in each position.

Typically, the player is given an option for rearranging one or more of the virtual playing cards in the matrix. In some embodiments, the player is limited by the number of virtual playing cards that may be rearranged. In other embodiments, the player is limited by time for rearranging the playing cards. Continuing with the game play, the game evaluates the matrix for winning poker combinations of virtual playing cards on the pay lines where the player placed a wager. The pay line identifies a plurality of virtual playing cards that make up a poker hand. The game pays a player a winning wager associated with a pay line having a winning poker combination. Typically, the winning wager is determined from a pay table and is based upon a multiple of the wager associated with a poker hand value.

In another embodiment, the players are dealt nine cards at a poker table or gaming table in a physical or virtual casino. Each player plays against an opponent (or multiple opponents, e.g. in a poker room) and forms a high hand in the top row, a middle hand in the second row, and a low hand in the third row. All players, including a dealer if present, form their three hands in a similar way. The three hands are then compared, high, middle and low, and any player that wins two out of three hands wins the round. If no one player wins 2 hands, then the game continues.

### Multi-Deck Matrix Poker

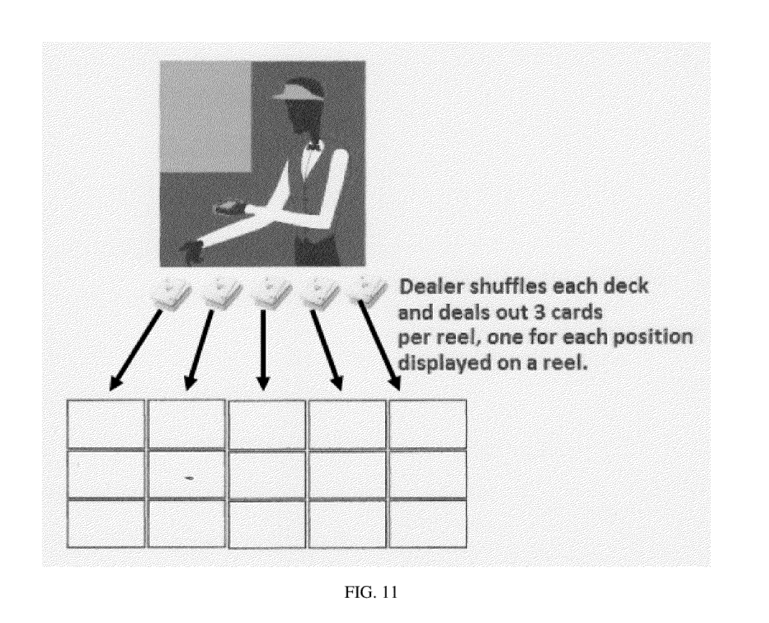

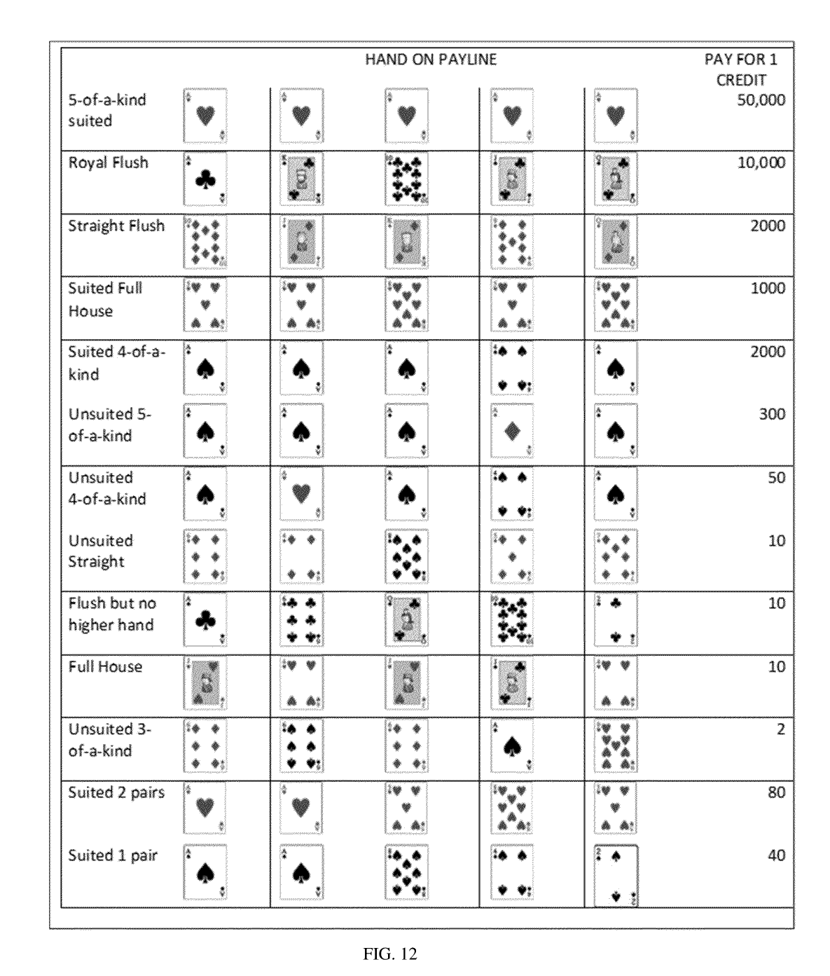

FIG. 11 is a visual depiction of the 5-deck reel poker, in which the symbols to be displayed on a reel are selected from a shuffled deck, one deck for each reel. In one embodiment, the illustrated game has five virtual reels and three positions on each reel shown to the player, which will be referred to as a 3×5 slot game. In the illustrated embodiment, a total of five sets of symbols or decks of cards are used in the game, one set for each virtual reel in a column. Continuing with the illustrated embodiment, each of the five decks is “shuffled,” and the three positions on each of the five virtual reels get one symbol or virtual playing card from a set of symbols, in this case a virtual deck of 52 virtual playing cards. The winning combinations include many of the 5-card poker hands, plus some new hands. A sample of hands in the 5-card poker game is presented in FIG. 12 of this document.

Continuing, FIG. 11 illustrates a schema of a 3×5 game, in which each of the five columns gets a card from a single deck, i.e., five single decks of playing cards are used, one for each column. In another embodiment, a total of C decks are combined and then shuffled to deal out poker hands. For example, a total of five decks are combined, shuffled together, and then five cards are dealt to each player.

The multi-deck video poker slot game can be offered as an R×C slot game, where R is the number of rows displayed to a player, and C is the number of reels or columns used in the slot game. In one embodiment, a 3×5 video poker slot game (R=3, C=5; 3 stops on each of 5 reels displayed to a player) is described. In one embodiment, there are a total of 52 symbols on each reel (52 cards in a standard deck of cards), i.e., a deck of cards is used for each of the 5 reels. Each of the five decks is shuffled separately, and three cards per reel are dealt, one for each display position. Winning hands and associated payouts for 1 credit wager are shown in the illustrated payout table of FIG. 12, with suited 5-of-a-kind being the highest hand. The winning hands are standard 5-card-poker hands, and some enhanced poker hands due to the fact that five decks are being used to create a five card poker hand. Note that not all of the standard 5-card-poker hands pay a positive amount.

In the payout table of FIG. 12, ‘suited’ refers to all five cards being drawn from the same suit, and ‘unsuited’ means that not all five cards are from the same suit. As an example, in the hand ‘suited 4 Aces of Hearts’, the non-Ace card is also from the hearts suit. It should also be noted that the triggers for the BONUS GAME and the FREE SPIN GAMES are not from the card decks, but are independently generated with specified probabilities.

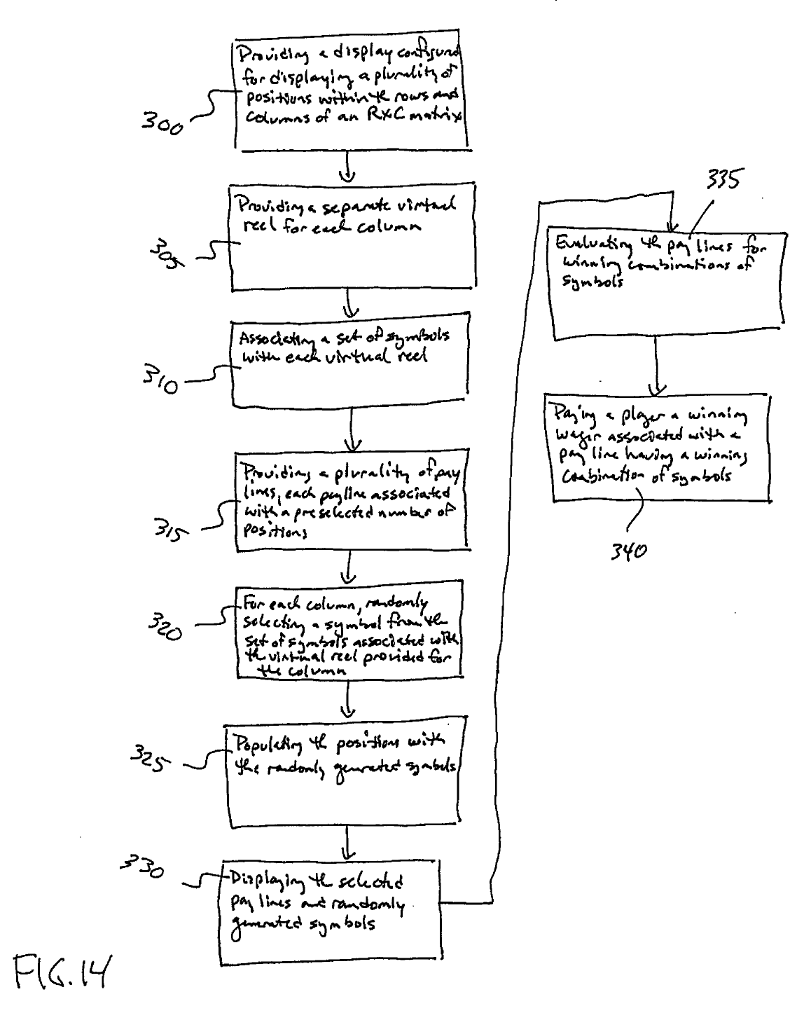

FIG. 14 illustrates a flowchart of the game play associated with one example of the multi-deck matrix poker game. In step 300, a display is provided configured for displaying a plurality of symbol positions within the rows and columns of the R×C matrix. In the illustrated embodiment, each symbol position is defined by the intersection of a row and a column and the number of symbol positions in each column are defined by the number of rows in the R×C matrix. In step 305, a separate virtual reel is provided for each column. Continuing with step 310, a set of symbols is associated with each virtual reel, where each set of symbols for each virtual reel are equal in number and identity. In step 315 a plurality of pay lines is provided, each pay line associated with a preselected number of positions from the plurality of symbol positions.

An indication of a wager associated with one or more of the pay lines is received from the player. In step 320, for each position in a column, a symbol from the set of symbols associated with the virtual reel provided for the column is randomly selected. The plurality of symbol positions associated with each column are then populated with the randomly generated symbols from the virtual reel provided for the column, as shown in step 325. Continuing, in step 330, the selected pay lines and the randomly generated symbols are displayed. In step 35, the pay lines having a wager associated therewith are evaluated for winning combinations of symbols, where the winning combinations identify a plurality of symbols that make up a predetermined combination of symbols in a pay table. Finally, in step 340, a player is paid a winning wager associated with a pay line having a winning combination of symbols, where the winning wager being determined based upon a multiple of the wager associated with the winning combination of symbols.

### The Random Bonus Game

As stated above, the player is awarded a BONUS with a specified probability. The game screen changes and goes into the Match Card Bonus round. Two versions of this game are illustrated and described.

Match Card Bonus Game 1: A shuffled standard deck of 52 cards is displayed, out of which one card is drawn by the player (say K♡). The player keeps drawing cards from the same deck until another K appears.

Match Card Bonus Game 2: Two shuffled standard decks of 52 cards each are displayed. The player selects one of the two decks. From the selected deck, one card is randomly drawn by the player (say K♡). The player keeps drawing cards from the other deck until another K appears.

In either of the two versions of the Match Card Bonus game, the award is a function of the number of cards drawn until the player draws the card to be matched.

### The Random Free Spin Game

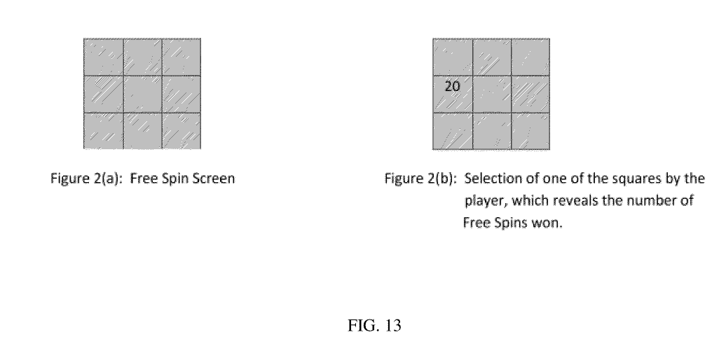

A random Free Spin trigger will send the slot game display into a Free Spin Screen, such as the one shown in FIG. 13. In operation, the player selects one of the squares and reveals a hidden number. If the revealed number is 20 as shown in FIG. 13, then the slot game goes into free spin mode, and the slot reels spin 20 times without any intervention from the player; a player can also be awarded a base award depending on the level of free spins won by the player. In the Free Spin mode, the player can win more free spin games.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A computerized method for playing an game having a number of rows R and a number of columns C arranged in an R×C matrix, where R defines the number of rows displayed to a player and where C defines the number of columns displayed to the player, the method comprising:
providing a display configured for displaying a plurality of symbol positions within the rows and columns of the R×C matrix, wherein each symbol position is defined by the intersection of a row and a column, wherein the number of symbol positions in each column are defined by the number of rows in the R×C matrix;
providing a separate virtual reel for each column;
associating a set of symbols with each virtual reel, wherein each set of symbols for each virtual reel are equal in number and identity;
providing a plurality of pay lines, each pay line associated with a preselected number of positions from the plurality of symbol positions;
receiving an indication of a wager associated with one or more of the pay lines from the player;
for each position in a column, randomly selecting a symbol from the set of symbols associated with the virtual reel provided for the column;
populating the plurality of symbol positions associated with each column with the randomly generated symbols from the virtual reel provided for the column;
displaying the selected pay lines and the randomly generated symbols;
evaluating the pay lines having a wager associated therewith for winning combinations of symbols, wherein the winning combinations identify a plurality of symbols that make up a predetermined combination of symbols in a pay table; and
paying a player a winning wager associated with a pay line having a winning combination of symbols, said winning wager being determined based upon a multiple of the wager associated with the winning combination of symbols.

2. The method of claim 1, wherein the R×C matrix is a 3×3 matrix having three rows and three columns.

3. The method of claim 1, wherein the R×C matrix is a 3×5 matrix having three rows and five columns.

4. The method of claim 1, wherein a player selects a number of pay lines for the wager and wherein the player only gets paid on a pay line if the player paid to activate the pay line.

5. The method of claim 4, wherein the player must pay for the desired pay lines prior to generating the virtual playing cards.

6. The method of claim 1, wherein the set of symbols is a single virtual deck of fifty-two virtual playing cards.

7. The method of claim 1, wherein the multiple of the wager associated with a pay line is determined by a pay table, the pay table arranged to show a multiple associated with a predetermined combination of symbols.

8. A computerized method for playing an game having a number of rows R and a number of columns C arranged in an R×C matrix, where R defines the number of rows displayed to a player and where C defines the number of columns displayed to the player, the method comprising:
providing a display configured for displaying a plurality of symbol positions within the rows and columns of the R×C matrix, wherein each symbol position is defined by the intersection of a row and a column, wherein the number of symbol positions in each column are defined by the number of rows in the R×C matrix;
providing a matrix having a plurality of positions arranged in rows and columns for receiving a plurality of virtual playing cards;
providing a plurality of pay lines, each pay line associated with a preselected number of positions from the plurality of symbol positions;
receiving an indication of a wager associated with one or more of the pay lines;
randomly selecting virtual playing cards and thereafter populating the plurality of symbol positions with the randomly generated virtual playing cards;
displaying the matrix and the virtual playing cards in each of the plurality of symbol positions;
providing an option for rearranging one or more of the virtual playing cards in the matrix;
evaluating the matrix for winning poker combinations of virtual playing cards on the pay lines having a wager associated therewith, wherein the pay line identifies a plurality of virtual playing cards that make up a poker hand; and
paying a player a winning wager associated with a pay line having a winning poker combination, said winning wager being determined based upon a multiple of the wager associated with a poker hand value.

9. The method of claim 1, wherein the R×C matrix is a 3×3 matrix having three rows and three columns.

10. The method of claim 1, wherein the R×C matrix is a 3×5 matrix having three rows and five columns.

11. The method of claim 1, wherein the plurality of pay lines comprises eight pay lines.

12. The method of claim 4, wherein the eight pay lines are associated with three rows, three columns and two diagonals in a 3×3 matrix.

13. The method of claim 4, wherein the eight pay lines are associated with three rows and five columns in a 3×5 matrix.

14. The method of claim 1, wherein a player selects a number of pay lines for the wager and wherein the player only gets paid on a pay line if the player paid to activate the pay line.

15. The method of claim 7, wherein the player must pay for the desired pay lines prior to generating the virtual playing cards.

16. The method of claim 1, wherein a single virtual deck of fifty-two virtual playing cards are used to generate the virtual playing cards in the plurality of positions in the matrix.

17. The method of claim 1, wherein the rearranging of one or more of the virtual playing cards in the matrix must be accomplished in a predetermined period of time.

18. The method of claim 1, wherein a predetermined number of the virtual playing cards in the matrix may be rearranged.

19. The method of claim 1, wherein the multiple of the wager associated with a pay line having a winning poker combination is determined by a pay table, the pay table arranged to show a multiple associated with a poker hand value.

20. A gaming system for playing a card game having a number of rows R and a number of columns C arranged in an R×C matrix, where R defines the number of rows displayed to a player and where C defines the number of columns displayed to the player, said gaming system comprising:
at least one input device;
at least one display; and
at least one controller operative to:
provide a plurality of symbol positions within the rows and columns of the R×C matrix, wherein each symbol position is defined by the intersection of a row and a column, wherein the number of symbol positions in each column are defined by the number of rows in the R×C matrix;
provide a plurality of pay lines, each pay line associated with a preselected number of positions from the plurality of symbol positions;
receive an indication of a wager associated with one or more of the pay lines from the player;
for each position in a column, randomly select a symbol from the set of symbols;
populate the plurality of symbol positions associated with each column with the randomly generated symbols;
display the selected pay lines and the randomly generated symbols;
evaluate the pay lines having a wager associated therewith for winning combinations of symbols, wherein the winning combinations identify a plurality of symbols that make up a predetermined combination of symbols in a pay table; and
pay a player a winning wager associated with a pay line having a winning combination of symbols, said winning wager being determined based upon a multiple of the wager associated with the winning combination of symbols.

21. The method of claim 20, wherein said symbols comprise a set of virtual playing cards.

22. The method of claim 20, wherein said controller is operative to rearrange one or more of the virtual playing cards in the matrix.

23. The method of claim 20, wherein said controller is further operative to:
provide a separate virtual reel for each column;
associate a set of symbols with each virtual reel, wherein each set of symbols for each virtual reel are equal in number and identity;
randomly select a symbol from the set of symbols associated with the virtual reel provided for the column; and
populate the plurality of symbol positions associated with each column with the randomly generated symbols from the virtual reel provided for the column.
